(19) United States
(12) Patent Application Publication
(10) Pub. No.: US 2006/0037600 A1
(43) Pub. Date: Feb. 23, 2006

(54) Transportable grill

(76) Inventors: Paul M. Baris, Bear, DE (US); Brian S. McMurtry, Terre Haute, IN (US); Deborah L. McMurtry, Terre Haute, IN (US)

Correspondence Address: Edward F. Behm, Jr., 2500 One Liberty Place, 1650 Market Street, Philadelphia, PA, 19103, US

(21) Appl. No.: 11/217,812

(22) Filed: Sep. 1, 2005

Related U.S. Application Data
(63) Continuation of application No. 10/652,722, filed on Aug. 29, 2003.

(51) Int. Cl. A47J 37/00

(52) U.S. Cl. 126/25 R

(57) ABSTRACT

The present invention is a transportable grill for accompanying a user to a remote event, such as a sports match. The transportable grill may include a lateral element and a vertical element, wherein the lateral element is adapted to be engaged to a receiver on a vehicle. The lateral element may additionally be provided with structure to allow the position of the lateral element to be adjusted relative to the vertical element, such that the vertical element and grill unit may raised or lowered relative to the vertical element to assist in positioning the transportable grill for engagement to a receiver.

### RELATED APPLICATIONS

This application is a continuation of U.S. patent application Ser. No. 10/652,722, filed Aug. 29, 2003, the entire disclosure of which is hereby incorporated by reference herein as if being set forth in its entirety.

### FIELD OF THE INVENTION

The present invention pertains to grills for cooking foods, and more particularly, to transportable grills for use at sporting events.

### BACKGROUND OF THE INVENTION

Sporting events may include pre-game festivities that occur in parking lots. One tradition of such festivities includes the preparation of barbecue-cooked food. Due to restrictions on the size of vehicles used to transport the attendants to the sporting event, as well as other accessories for pre-game festivities, the barbecues may typically be limited to small table-top “hibachi” type barbecues, which may be limited as to the type and amount of food which may be prepared at a given time. These style grills may also require attendants to kneel down to cook.

Attendants utilizing larger vehicles, such as pick-up trucks, may fit larger barbecues, however loading and unloading such barbecues may be cumbersome and dangerous. To solve this problem, barbecues adapted to engage a trailer receiver hitch have been developed. For example, see U.S. Pat. No. 5,640,949. These barbecues typically use the square receiver portion of the hitch to engage a square post extending from the barbecue grill. The mounting provisions provide for these barbecues to remain attached to the receiver hitch while food is barbecued in the barbecue. Such placement may limit the ability of the owner of a vehicle to which the barbecue is attached to access the vehicle while the barbecue is lit, as well as to limit the ability to locate the barbecue away from the vehicle during operation. Additionally, such barbecues may provide a safety hazard, as the hot barbecue grill, when in use, may be located adjacent to trunks and rear mounted gas tanks, especially where the barbecue grill is attached to a receiver hitch mounted to a car, rather than to a pick-up truck.

Although the present invention may be beneficially used for festivities at sporting events, the utility of the present invention is not limited to such events.

### SUMMARY OF THE INVENTION

The present invention is a transportable grill for accompanying a user to a remote event, such as a sports match. The transportable grill may include a lateral element and a vertical element, wherein the lateral element is adapted to be engaged to a receiver on a vehicle. The lateral element may additionally be provided with structure to allow the position of the lateral element to be adjusted relative to the vertical element, such that the vertical element and grill unit may raised or lowered relative to the vertical element to assist in positioning the transportable grill for engagement to a receiver or use.

In one embodiment, the transportable grill may include a lateral element, a vertical element, and a grill unit. The lateral element may have a mounting element and a junction element. The junction element may be implemented such as to allow the lateral element to move vertically relative to the vertical element to allow alternately positioning the junction element and associated lateral element in travel and use positions.

In another embodiment, the transportable grill may include a lateral element which is hinged relative to the vertical element, such that the angle between the vertical element and the lateral element may be adjusted to allow engagement of the tongue into a receiver hitch while the grill remains supported by the ground.

In an alternate embodiment, the transportable grill may include a lateral element, a vertical element, and a grill unit. The lateral element may further include a means for engaging a vehicle receiver for engaging said transportable grill to the vehicle. The lateral element may further include a means for varying the position of the horizontal element relative to the vertical element.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an isometric view of a transportable grill according to the present invention, showing the grill as having an aesthetic form associated with a sport;

FIG. 2 illustrates a side view of a transportable grill according to the present invention, showing the grill as having an aesthetic form associated with a sport;

FIG. 3 illustrates a side view of a transportable grill according to the present invention, showing the lateral element hinged at the junction element to allow mating of the lateral element with a receiver hitch;

FIG. 4 illustrates a side view in cross section of the vertical and lateral elements of a grill according to the present invention, showing a first fixing method;

FIG. 5 illustrates a side view in cross section of the junction element, lateral element, and vertical element of a grill according to the present invention, utilizing a hinged engagement between the lateral element and the junction element;

FIG. 6 illustrates a top view in partial cross section of the engagement zone between a receiver hitch as would be associated with a vehicle engaged to a grill according to the present invention, showing a first retention method;

FIG. 7 illustrates a top view in partial cross section of the engagement zone between a receiver hitch as would be associated with a vehicle engaged to a grill according to the present invention, showing a second retention method;

FIG. 8 illustrates a side view in cross section of the junction element, lateral element, and vertical element of a grill according to the present invention, showing an alternate fixing method;

FIG. 9 shows a lift assist device in an isometric view for assisting a user in positioning the vertical element relative to the lateral element;

FIG. 10 shows a transportable grill assembly having a height adjustable vertical element;

FIG. 11 illustrates a transportable grill engaged to a vehicle;

FIG. 12 illustrates an embodiment of a hinge mechanism for the grill shown in FIG. 11;

FIG. 13 shows an anti-tip feature for the grill shown in FIG. 11;

FIG. 14 illustrates a view of the transportable grill;

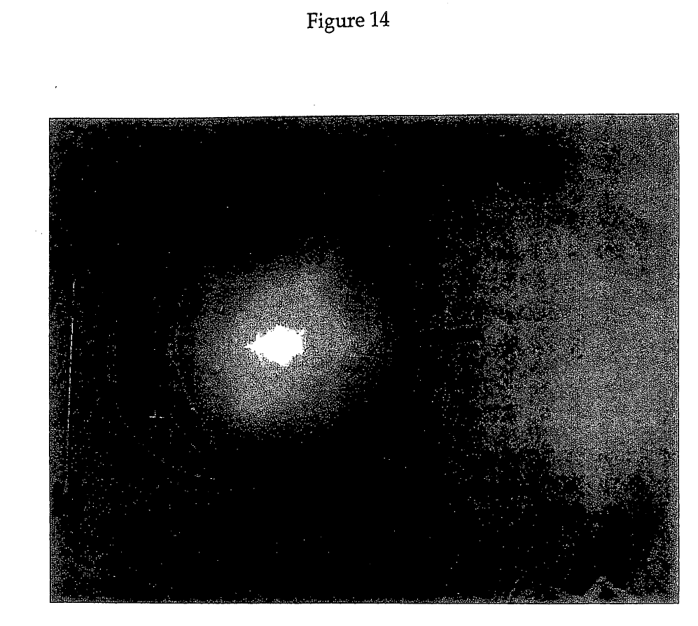

FIG. 15 illustrates a view of the transportable grill;

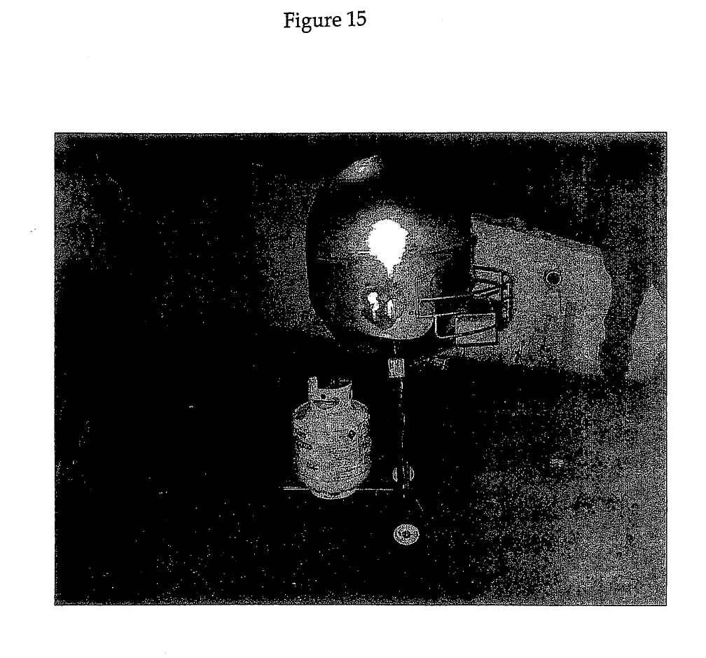

FIG. 16 illustrates a view of the transportable grill;

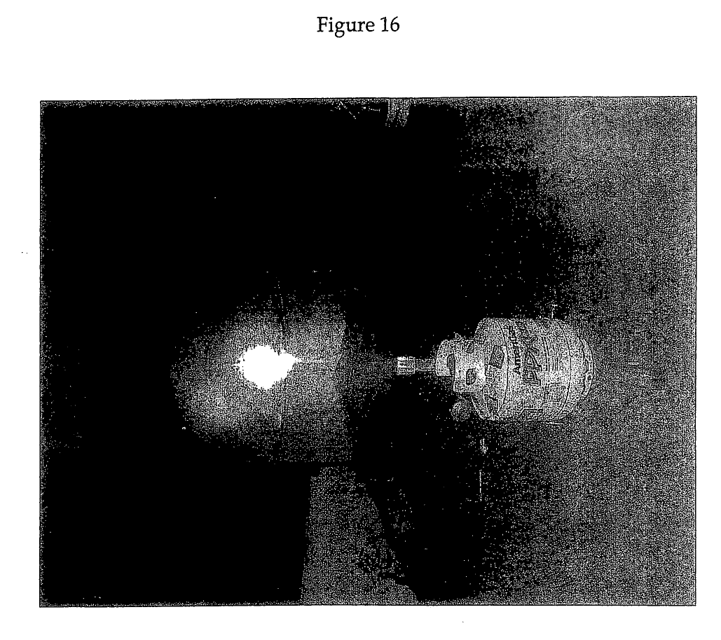

FIG. 17 illustrates a view of the transportable grill; and

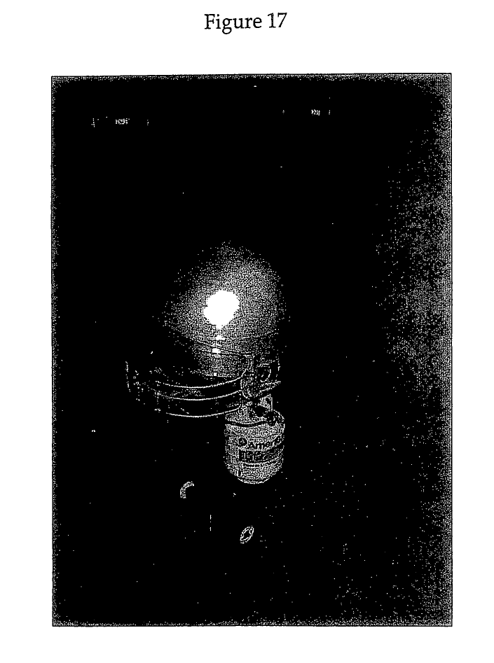

FIG. 18 illustrates a view of the transportable grill.

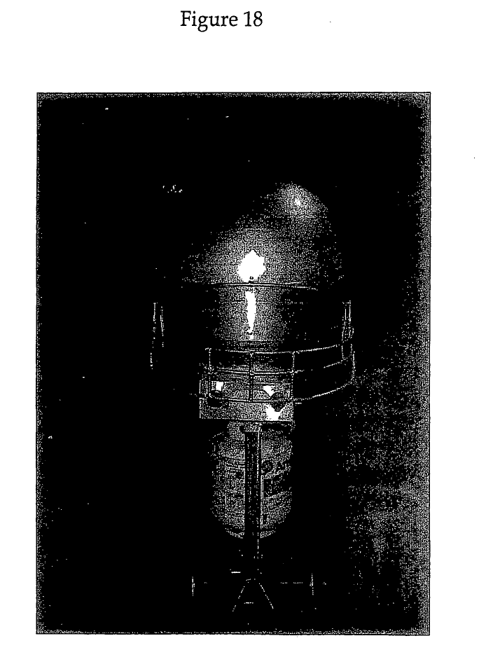

### DETAILED DESCRIPTION OF THE PREFERRED EMBODIMENTS

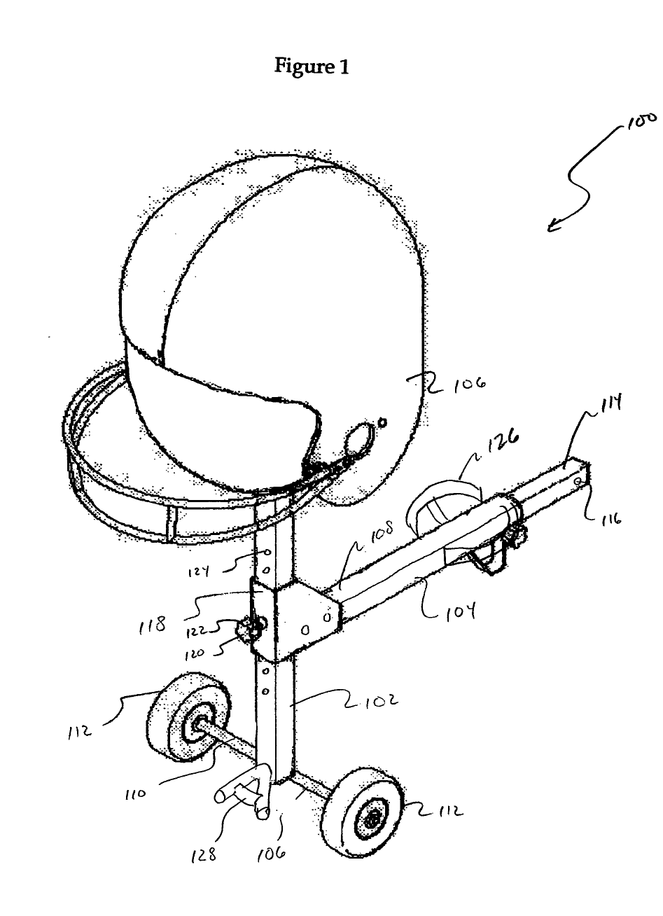

As shown in the Figures, wherein like numbers represent like elements, the transportable grill 100 of the present invention may be formed from a vertical element, a lateral element, and a grilling unit 106 attached to the top of the vertical element. The lateral element may have a first end that is slidably engaged to the vertical element, allowing the position of the lateral element to be varied between an in-use position and a travel position. The bottom of the element may be provided with a foot element 108. As shown in FIG. 1, the foot element may be an axle 110 disposed substantially orthogonal to the vertical element and the lateral element. Where an axle is utilized, wheels 112 may placed on the ends of the axle to allow easy movement of the grill unit 100 when the grill unit 100 is detached from a vehicle (not shown).

The lateral element may be adapted to be inserted into a hitch receiver on a vehicle. Preferably, the hitch receiver will have a square or rectangular inner pocket susceptible to receiving a slightly smaller square or rectangular cross sectioned mating element 114 on the lateral element. The mating element 114 may be attached to the lateral element 104, or may be an integral portion of the lateral element 104. The mating element 114 may be provided with a feature 116 for retaining the mating element 114 to the receiver hitch, such as a through hole through which a retaining pin or pins may be placed to retain the mating element 114 to the receiver hitch.

The junction between the lateral element 104 and the vertical element 102 may be formed through the use of a junction element 118 attached to the lateral element 104 having a slightly larger internal through cavity than the outer cross section of the vertical element 102, such that the junction element 118 may slidably surround the vertical element 104. The junction element may be either a separate piece attached to the lateral element, or an integral portion of the lateral element. A locking feature 120 may be provided to allow the position of the junction element 118 to be fixed relative to the vertical element 102. The locking feature 120 may comprise a pin 122 that engages one of a plurality of engagement holes 124 dependent upon a desired position of the junction element 118 relevant to the vertical element 102. Alternately, the locking feature 120 may be a device which bears against the vertical element 102 when in a locked position, such that friction between the vertical element 102 and the locking element 120 prevents the vertical element 102 from moving relative to the junction element 120.

A mounting feature 126 for attaching an energy source for the grill unit 100, such as but not limited to propane tanks, may be attached to the lateral element 104. Placement of the mounting feature 126, and association of an energy source with the mounting feature 126, may beneficially shift the center of gravity of the grill unit 100 closer to the centroid of any ground contact points. An anti-tip feature 128 may be provided to limit the ability of the grill assembly 100 to tip relative to the foot element 106.

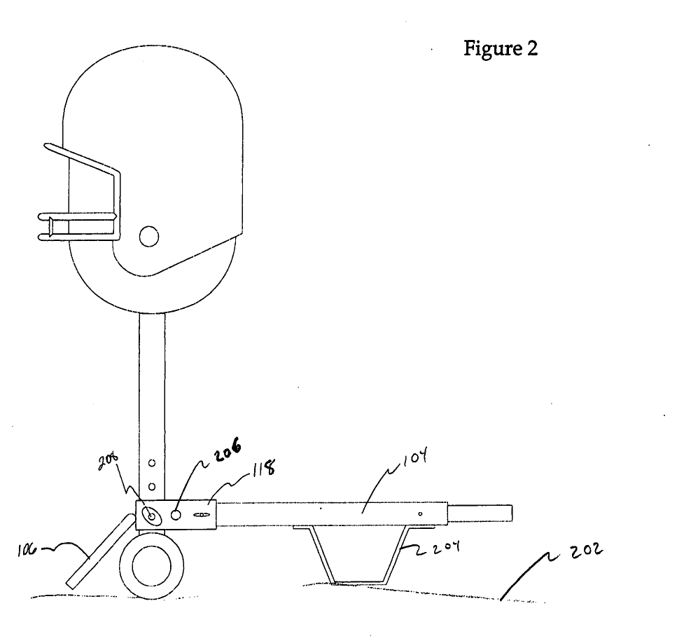

As shown in FIG. 2, the lateral element 104 may have a lower position at which the foot element 106 may rest against a surface 202. A rest element 204 may be attached to the lateral element 104 to provide further support for the grill assembly 100 to provide stability while the grill assembly is in use. A hinge pin 206 may be provided, such that the lateral element 104 can rotate relative to the junction element. A pin 208 and through hole (not shown) may be provided to allow the lateral element to be fixed relative to the junction element 118.

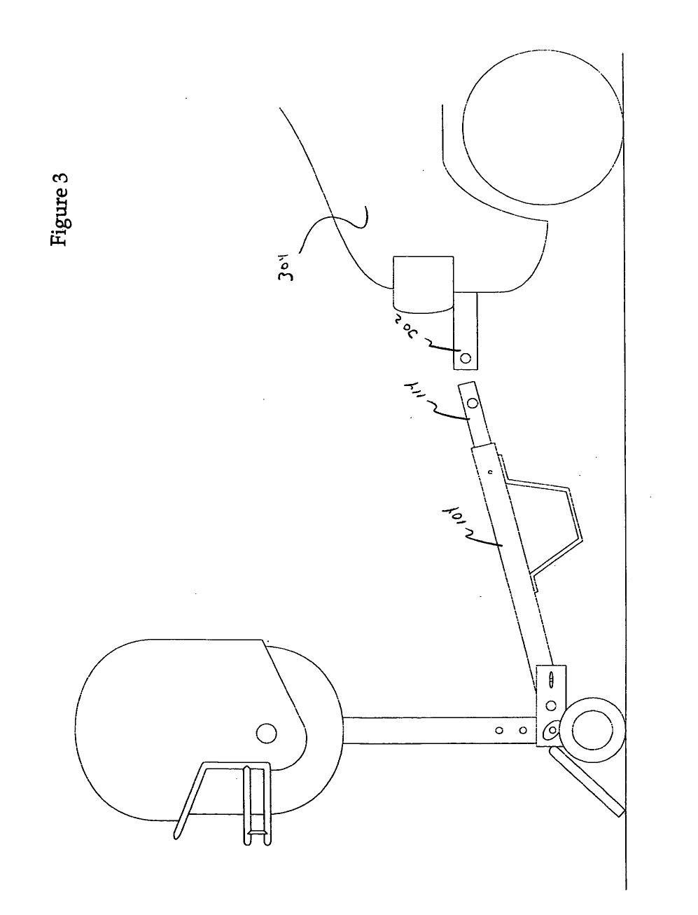

As shown in FIG. 3, the lateral element may be rotated upward to allow engagement of the mating element 114 to a receiver hitch 302 attached to a vehicle 304. A lower edge 306 of the mating element may be rested against the receiver hitch 302, allowing a user to either raise the junction element until the mating element engages the receiver hitch, or the entire grill assembly may be lifted to allow the mating element to engage the receiver hitch.

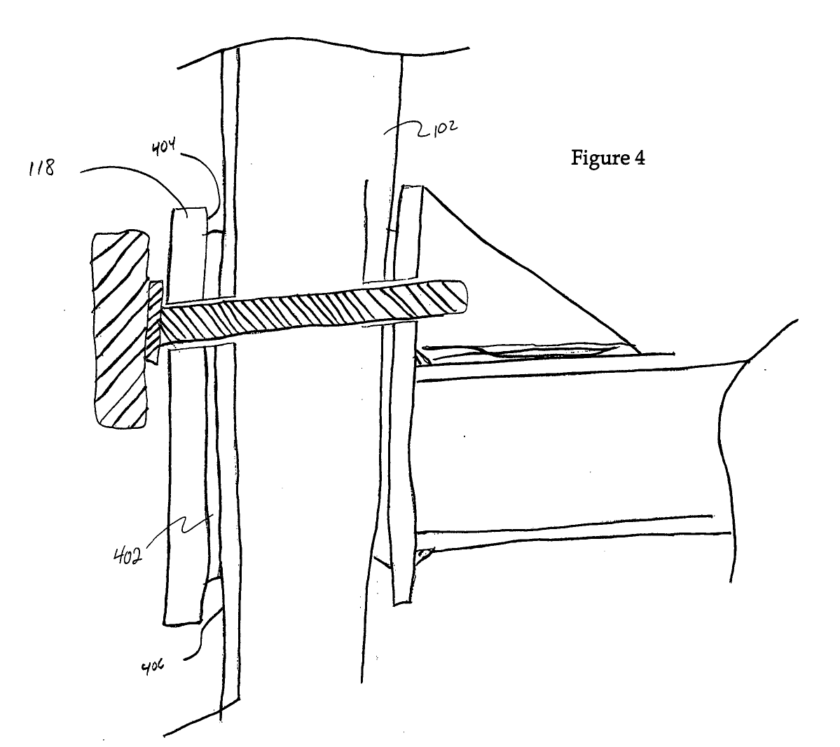

As shown in FIG. 4, the junction element 118 may be provided with slipper elements 402, such as Teflon sheet material, between the inner surface 404 of the junction element 118 and the vertical element 102 to reduce friction between the elements. As shown, the locking element may be a pin which extends through both the junction element and the vertical element to prevent translation of the junction element relative to the vertical element. As shown in FIG. 4, the lateral element 104 may be fixed relative to the junction element.

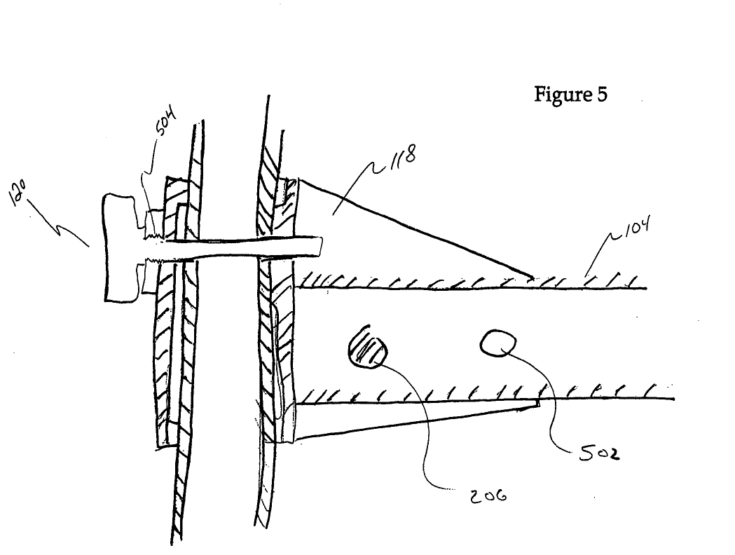

As shown in FIG. 5, the junction element 118 may be provided with a hinge pin 206 to allow the lateral element 104 to rotate relative to the junction element 118. A through hole 502 may be provided to allow rotation of the lateral element 104 to be constrained relative to the junction element 118. Also as shown, the locking feature 120 may be provided with a threaded portion 504 which engages with a threaded portion of the junction element 118 to retain the locking feature 120 to the junction element 118.

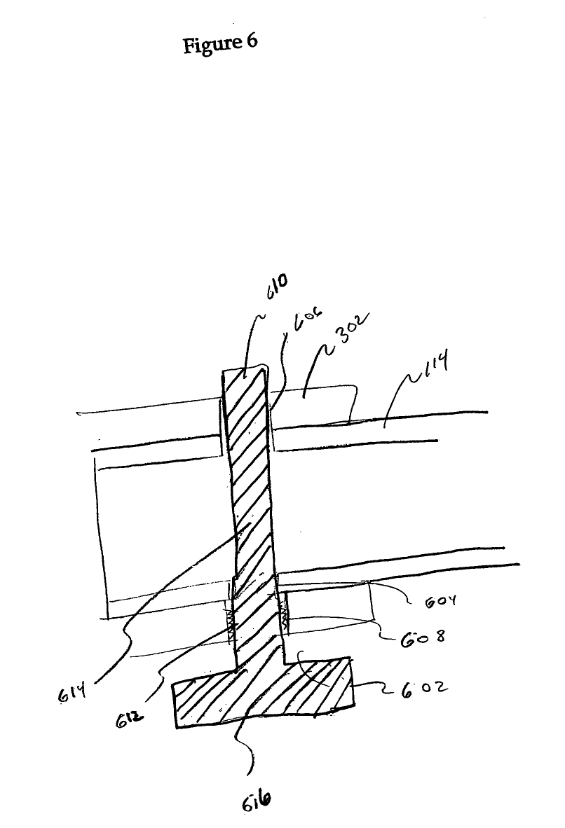

As shown in FIG. 6, the junction between the mating element 114 and a receiver hitch 302 may be fixed through the inclusion of a pin 602 which is interposed though holes 604, 606 in both the receiver hitch 302 and the mating element 114. The pin 602 may be formed by the inclusion of a shaft 610 having a threaded portion 612 and a smooth portion 614. The smooth portion may 614 be tapered, as may be the receiving hole in the mating element 114, to improve the tightness of the contact between the smooth portion 614 and the receiving hole 606. The pin 602 may be provided with a grip 616 to assist a user in turning the threaded portion 612 of the pin 602 to cause engagement of the smooth surface 614 against the receiving hole 606.

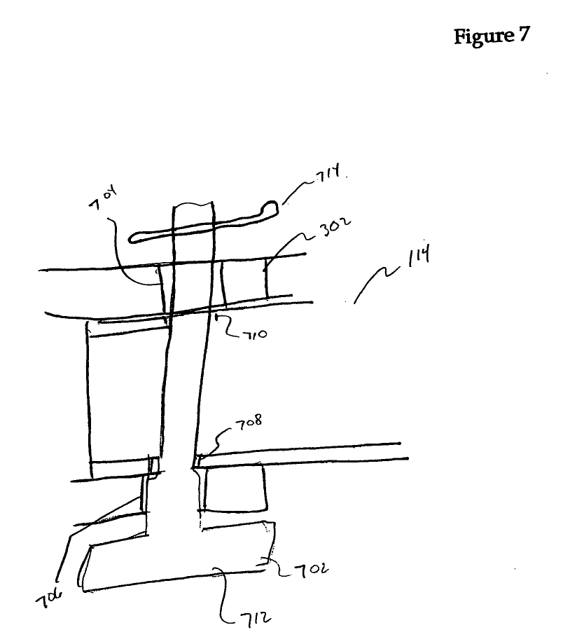

FIG. 7 shows an alternate feature for retaining the mating element 114 to a receiver hitch 302, such as would be desirable when the transportable grill 100 was being transported. A through pin 702 may be selected to pass through receiver hitch retainer holes 704, 706 and mating element retainer holes 708, 710 to prevent the mating element 114 from sliding out of the receiver hitch 302 during transport of the transportable grill 100. The through pin 702 may be provided with a grip 712 to assist a user in inserting the through pin 702 through the receiver hitch retainer holes 704, 706 and the mating element retainer holes 708, 710. Additional, a feature may be provided, such as a clevis pin 714, cotter pin, or retaining clip, to prevent the through pin 702 from unintentionally becoming withdrawn from the receiver hitch retainer holes 704, 706 or the mating element retainer holes 708, 710.

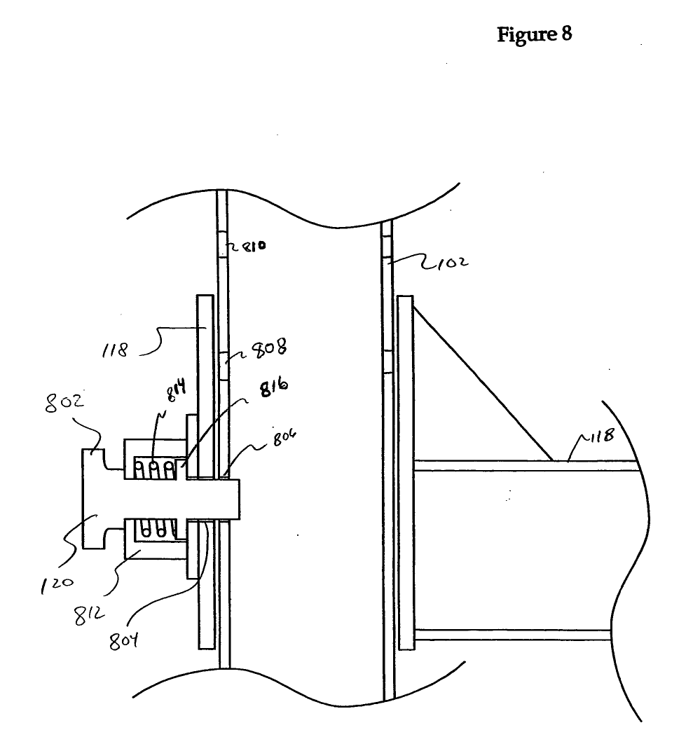

As shown in FIG. 8, the locking feature 120 between the junction element 118 and the vertical element 102 may comprise a spring biased height adjustment pin 802. The spring biased pin 802 may extend through a first hole 804 in the junction element 118 into a height positioning hole 806 in the vertical element 102. The vertical element 102 may have a plurality of height adjustment holes 808, 810, such that the pin 802 can be inserted into alternate height adjustment holes dependant on the desired positioning of the junction element 118 relative to the vertical element 102. A housing 812 may be provided to trap an elastic element 814 such as a spring between the housing element 812 and a shoulder 816 on the height adjustment pin 802, thus biasing the height adjustment pin 802 into a height adjustment hole 806, 808, 810. The pin 802 and height adjustment holes 806, 808, 810 may be tapered to provide a solid fit between the height adjustment holes 806, 808, 810 and the height adjustment pin 802. Alternately, the height adjustment pin 802 may alternately use a threaded feature (not shown) to allow the height adjustment pin 802 to be forced into engagement with a height adjustment hole.

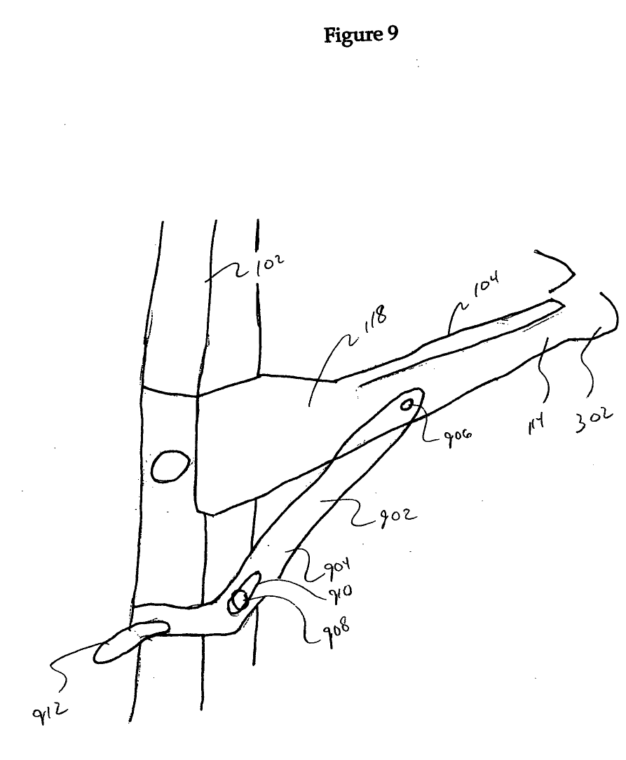

As shown in FIG. 9, a lift assist device 902 may be provided to assist in repositioning the junction element 118 (and thus the lateral element) relative to the vertical element 102. The lift assist 902 may be a lever 904 rotating about a pin 906 on the lateral element 104 and a pin 908 on the vertical element 102. The lever 904 may be provided with a slot 910 for the pin 908 constraining motion of the lever 904 relative to the vertical element 102, such that the translation of the lever 904 relative to the vertical element pin 908 does not bind the lever 904 against the lateral element pin 906.

The lever 904 may be provided with a handle 912, such that the action of a user in lifting the handle 912 provides a mechanical advantage in raising the vertical element 102 and associated grill relative to the lateral element 104. Accordingly, with the grill unit 100 positioned adjacent to a receiver hitch 302 to which the grill unit 100 is to be connected, the junction element 118 can be released from the vertical element 102, and slid upwardly so that the mating element 114 may be mated with a receiver hitch 302. Since the foot (not shown) of the grill unit 100 is not intended to remain in contact with the ground while in transit, the vertical element 102 would need to be raised a sufficient distance above the ground to allow the grill unit 100 to transit behind a vehicle to which the receiver hitch 302 is connected without striking the ground. Thus, once the mating element 114 has been joined to the receiver hitch 302, the vertical element 102 may be raised relative to the lateral element 104 through the lifting of the handle 912 until the vertical element 102 is in a raised position, at which point the vertical element 102 can be re-locked relative to the lateral element 104. Alternately, if no lifting device 902 is provided, a user may manually lift the vertical element 102 and grill unit 100 to a travel position, and re-lock the junction element 118 relative to the vertical element 102.

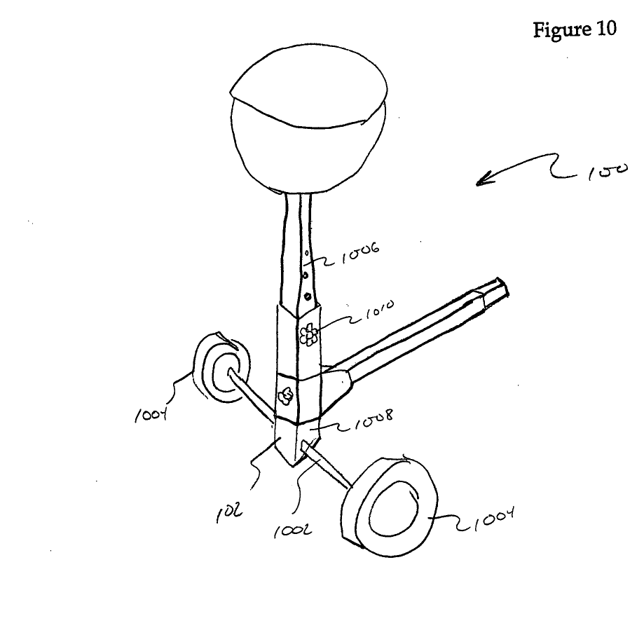

As shown in FIG. 10, the foot may include a crossbar 1002. Wheels 1004 may be mounted at the distal ends of the crossbar 1002, or near the junction of the crossbar 1002 and the vertical element 102, such that a slight tipping of the transportable grill would allow the transportable grill 100 to be wheeled to a location away from a transport vehicle. The vertical element 102 may be connected to the crossbar 1002, and extend upwardly for a distance controlled by the desired height adjustment potential between the lateral element and the crossbar. Such a height adjustment potential may be implemented by forming the vertical element from an inner tube 1006 and an outer tube 1008. A through pin 1010 may be provided to fix the inner tube 1006 relative to the outer tube 1008.

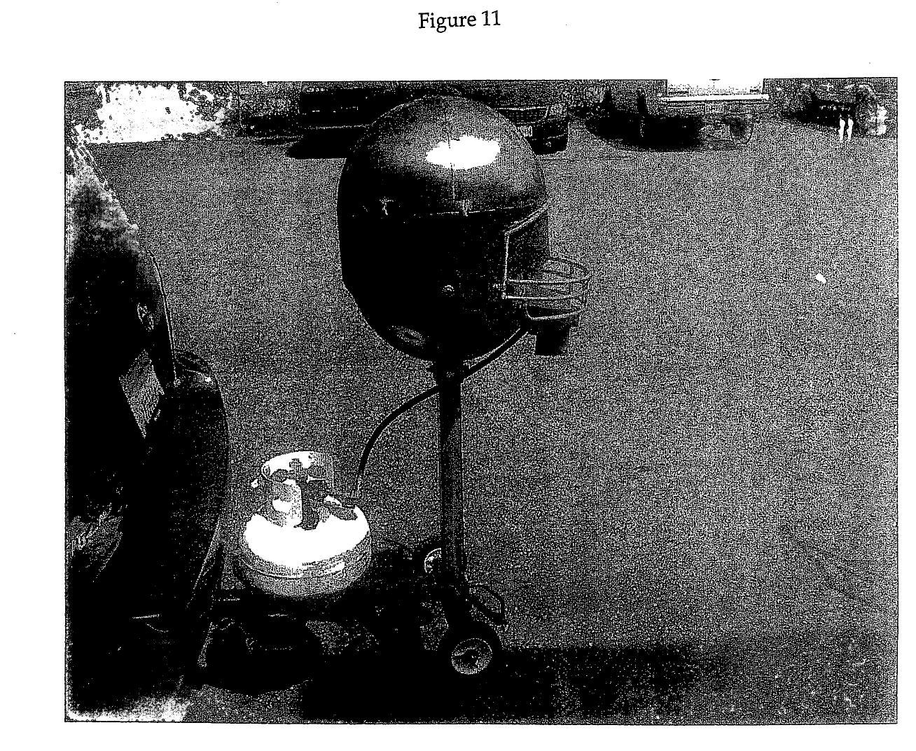

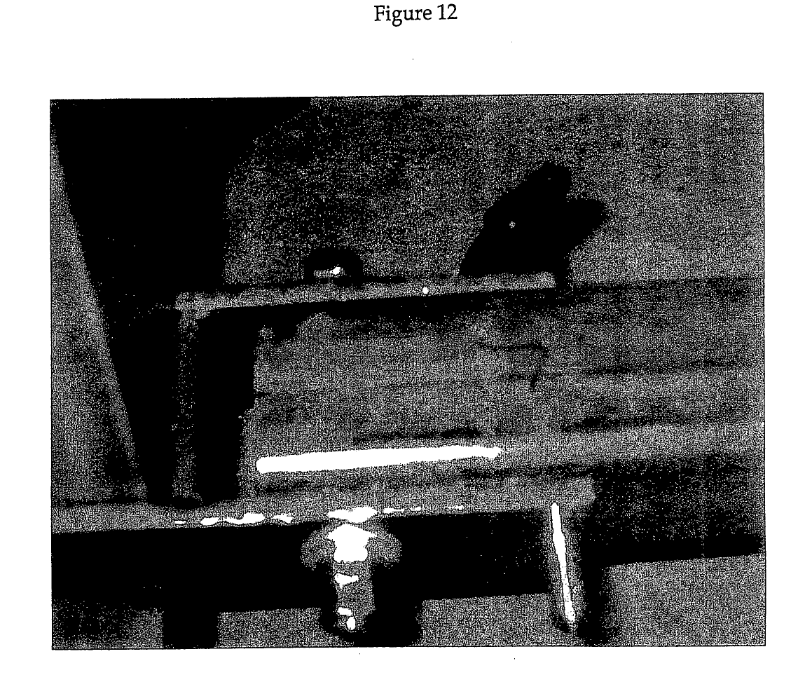

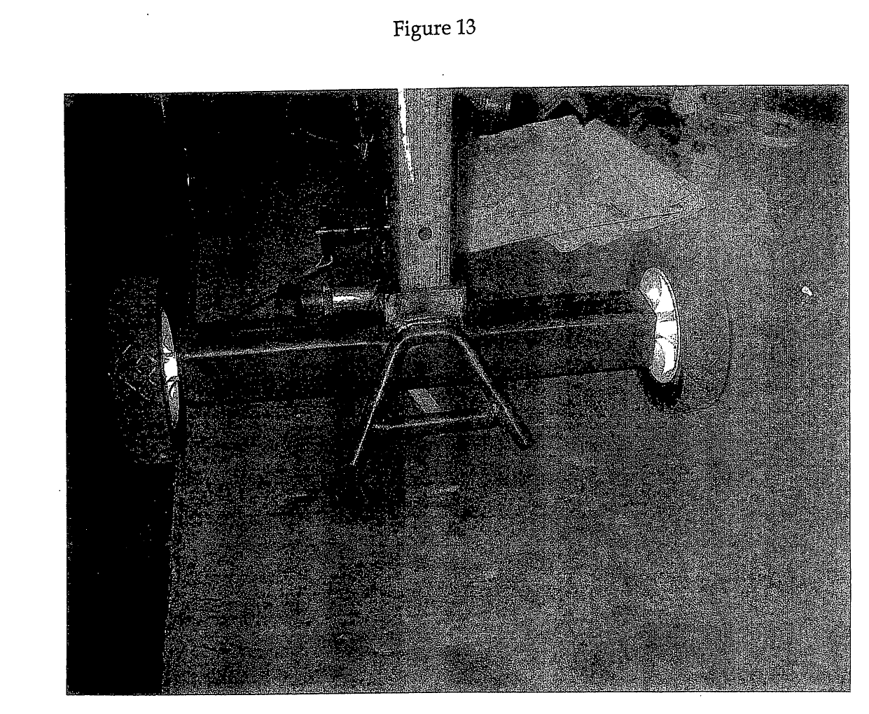

As shown in FIG. 11, an aesthetically pleasing form may be implemented for the grill portion of the transportable grill assembly. An energy source may be attached to the lateral element, such that the transportable grill assembly includes all components required for the transportable grill assembly to be utilized at a sporting event. FIG. 12 shows details of one implementation of a hinged junction between a lateral element and a junction element. FIG. 13 shows an implementation of an anti-tip feature.

The present invention may be embodied in other specific forms without departing from the spirit or essential attributes of the invention. Accordingly, reference should be made to the appended claims, rather than the foregoing specification, as indicating the scope of the invention.

1. A transportable grill comprising a lateral element, a vertical element, and a grill unit, said vertical element and said lateral element each comprising a ground engaging portion, said lateral element comprising a mounting element and a junction element, wherein said junction element allows traverse of the junction element relative to the vertical element to allow alternately positioning the junction element and associated lateral element in travel and use positions.

2. A transportable grill according to claim 1, wherein said junction element further comprises a locking feature for locking the position of the junction element relative to the vertical element.

3. A transportable grill according to claim 1, wherein said mounting element further comprises a retention feature to retain said mounting element in a receiver hitch when said mounting feature is engaged to a receiver hitch.

4. A transportable grill according to claim 1, wherein said transportable grill further comprises a lifting device for assisting a user in positioning the junction element relative to the vertical element.

5. A transportable grill according to claim 1, wherein said lateral element furthermore is hinged relative to the junction element.

6. A transportable grill according to claim 1, wherein said vertical element may be adjusted to vary the location of a grill connected to said vertical element.

7. A transportable grill comprising a lateral element, a vertical element, and a grill unit, said vertical element and said lateral element each comprising a ground engaging portion, said lateral element further comprises a means for engaging a vehicle receiver for engaging said transportable grill to a vehicle, and wherein said lateral element further comprises a means for varying the position of the horizontal element relative to the vertical element.

8. A transportable grill according to claim 7, further comprising a means for fixing the position of the lateral element at least one position relative to the vertical element.

9. A transportable grill according to claim 7, further comprising a means for retaining said lateral element in a vehicle receiver when said lateral element is engaged to said vehicle receiver.

10. A transportable grill according to claim 7, further comprising a means for lifting the vertical element relative to the lateral element to assist in positioning said transportable grill in a travel position.
